(19) United States
(12) Patent Application Publication
(10) Pub. No.: US 2019/0129632 A1
(43) Pub. Date: May 2, 2019

(54) DETERMINING IDENTIFYING INFORMATION FROM ENTERPRISE STORAGE PLATFORM

(71) Applicant: salesforce.com, inc., San Francisco, CA (US)

(72) Inventors: Ian William Hoskins, Carmel, IN (US); Steve Winkler, Carmel, IN (US)

(21) Appl. No.: 15/799,632

(22) Filed: Oct. 31, 2017

(51) Int. Cl. G06F 3/06

(52) U.S. Cl. CPC G06F 3/0629; G06F 3/067; G06F 3/0604

(57) ABSTRACT

Storage scripting, executed by a processing device on a host machine, provides an indication of a masking view to a storage platform and receives a data array comprising an indication of a contents of the masking view. The storage scripting identifies at least one host machine from the contents of the masking view, sends a first command to the storage platform to identify storage devices associated with the at least one host machine and receives an indication of one or more storage devices associated with the at least one host machine. The storage scripting further sends a second command to the storage platform requesting a logical unit identifier associated with at least one of the one or more storage devices, receives the logical unit identifier, and updates the data array to reflect the logical unit identifier.

### TECHNICAL FIELD

This disclosure relates to the field of enterprise storage platforms, and in particular to determining identifying information from an enterprise storage platform.

### BACKGROUND

“Cloud computing” services provide shared resources, software, and information to computers and other devices upon request or on demand. Cloud computing typically involves the over-the-Internet provision of dynamically-scalable and often virtualized resources. Technological details can be abstracted from end-users, who no longer have need for expertise in, or control over, the technology infrastructure “in the cloud” that supports them. In cloud computing environments, software applications can be accessible over the Internet rather than installed locally on personal or in-house computer systems. Some of the applications or on-demand services provided to end-users can include the ability for a user to create, view, modify, store and share documents and other files.

### BRIEF DESCRIPTION OF THE DRAWINGS

The present invention will be understood more fully from the detailed description given below and from the accompanying drawings of various embodiments of the present invention, which, however, should not be taken to limit the present invention to the specific embodiments, but are for explanation and understanding only.

FIG. 1 is a block diagram illustrating the determining of identifying information from an enterprise storage platform, according to an embodiment.

FIG. 2 is a block diagram of an exemplary network architecture, in which embodiments of the present disclosure may operate.

FIG. 3 is a block diagram illustrating storage scripting, according to an embodiment.

FIG. 4 is a flow diagram illustrating a method of determining identifying information from an enterprise storage platform, according to an embodiment.

FIG. 5 is a block diagram illustrating an example environment in which an on-demand database service can be used, according to some embodiments.

FIG. 6 is a block diagram illustrating an example implementation of elements of FIG. 5 and example interconnections between these elements according to some embodiments.

FIG. 7A shows a system diagram of example architectural components of an on-demand database service environment, according to some embodiments.

FIG. 7B shows a system diagram further illustrating example architectural components of an on-demand database service environment, according to some embodiments.

FIG. 8 is a block diagram illustrating an exemplary computer system, according to an embodiment.

### DETAILED DESCRIPTION

Embodiments are described for determining identifying information from an enterprise storage platform. In one embodiment, the enterprise storage platform includes a number of host machines and a number of corresponding data storage devices. The enterprise storage platform may be scalable to adjust the number of host machines and storage devices according to the needs of the enterprise. The enterprise storage platform can be utilized by members of the enterprise (e.g., via network enabled client devices) to provide data storage and cloud computing services.

Within the enterprise, a storage team may be responsible for provisioning storage in the enterprise storage platform in response to customer requests or the needs of the enterprise. For example, in one embodiment, the storage team may provision a logical unit (i.e., LUN) or a volume on the enterprise storage platform and mask (i.e., assign) it to a corresponding host machine. In order to make the provisioned storage usable by a server administration team, for example, the storage team may provide the server administration team with certain documentation of the provisioned storage including a logical unit identifier (i.e., LUN ID) and/or other information. Depending on the particular implementation of enterprise storage platform, this information can be difficult to obtain, typically involving a cumbersome process of multiple command line prompts and manual cross-referencing of the results. In one embodiment, the techniques described herein provide for an process that simplifies the tasks of the storage team by extracting documentary information about provisioned storage and automating the cross-referencing to obtain the logical unit identifier and make it available to the server administration team and/or others. Additional details of these techniques for identifying information from an enterprise storage platform are provided below.

I. Determining Identifying Information from Enterprise Storage Platform

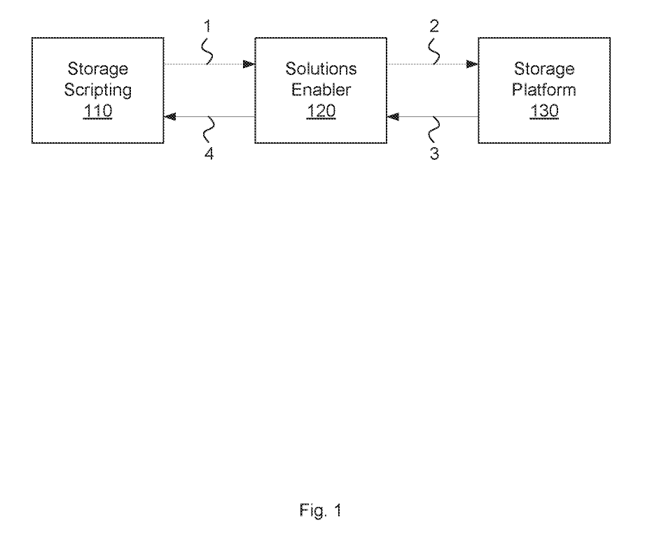

FIG. 1 is a block diagram illustrating the determining of identifying information from an enterprise storage platform, according to an embodiment. In one embodiment, there are three components involved in the process of determining of identifying information from an enterprise storage platform: storage scripting 110, solutions enabler 120, and storage platform 130. As described above, storage platform 130 may provide data storage and cloud computing services members of an enterprise, customers of the enterprise, and/or other users. In one embodiment, storage platform 130 includes the VMAX® enterprise storage platform from EMC Corporation of Hopkinton, Mass.

In one embodiment, the solutions enabler 120 includes a command line software program designed to interface with storage platform 130. Solutions enabler 120 may have a number of defined commands that can be entered to extract various data items from storage platform 130 and/or cause storage platform 130 to take various actions. In one embodiment, the solutions enabler 120 runs on a host machine (e.g., a management node) in a data center where storage platform 130 is located. In one embodiment, storage scripting 110 includes logic designed to interface with solutions enabler 120 and may run on the same host machine as solutions enabler 120 or on a different host machine. In one embodiment, storage scripting 110 may be configured to interact directly with storage platform 130 via certain application programming interfaces (APIs) exposed by storage platform 130, thereby eliminating any interaction with solutions enabler 120.

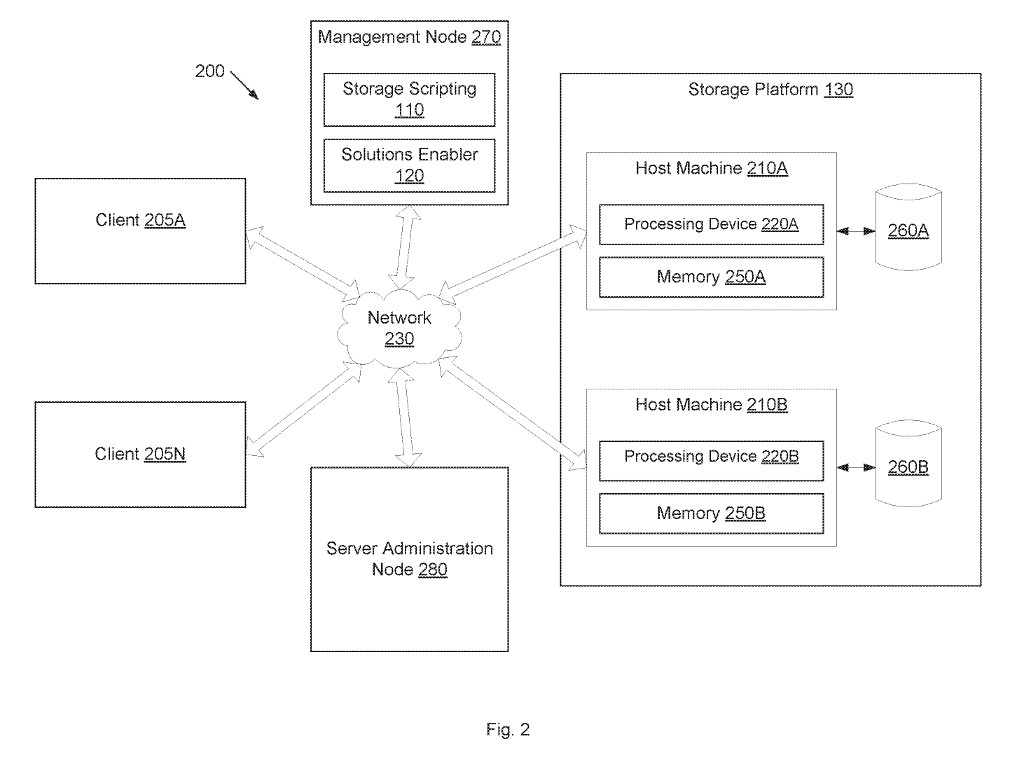

In one embodiment, storage scripting 110 automates the running of commands by solutions enabler 120 against storage platform 130 and correlates the data received from storage platform 130 to make it usable by the enterprise. For example, in one embodiment, at step 1, storage scripting 110 issues one or more commands to solutions enabler 120. At step 2, solutions enabler 120 queries storage platform 130 for the information specified in the commands from storage scripting 110. At step 3, storage platform 130 returns the requested information to solutions enabler 120. At step 4, solutions enabler 120 provides a data array including the requested information to storage scripting 110. In one embodiment, steps 1-4 may be repeated multiple times to obtain different data items or pieces of information from storage platform 130. In one embodiment, storage scripting 110 may cross-reference or correlate the different pieces of information and update the data array accordingly. Specific details related to the commands and pieces of information utilized by storage scripting 110 are provided below with respect to FIGS. 2-4.

FIG. 2 is a block diagram of an exemplary network architecture 200, in which embodiments of the present disclosure may operate. In one embodiment, the network architecture 200 includes storage platform 130 including one or more host machines 210A-210B, which may be employed to provide cloud computing services to one or more client devices 205A-205N. The client devices 205A-205N may communicate with host machines 210A-210B via one or more networks 230. Client devices 205A-205N are representative of any number of clients which may communicate with host machines 210A-210B for storing and accessing data in network architecture 200. Client devices 205A-205N are representative of any number of stationary or mobile computers such as desktop personal computers (PCs), servers, server farms, workstations, laptops, handheld computers, servers, personal digital assistants (PDAs), smart phones, and so forth. It is noted that some systems may include only a single client device, connected directly or remotely, to host machines 210A-210B.

In alternative embodiments, the number and type of client devices, host machines, and data storage devices is not limited to those shown in FIG. 2. At various times one or more clients may operate offline. In addition, during operation, individual client device connection types may change as users connect, disconnect, and reconnect to network architecture 200. Further, the systems and methods described herein may be applied to directly attached computing systems or network attached computing systems and may include a host operating system configured to perform one or more aspects of the described methods. Numerous such alternatives are possible and are contemplated.

In one embodiment, network 230 may utilize a variety of techniques including wireless connections, direct local area network (LAN) connections, wide area network (WAN) connections such as the Internet, a router, storage area network, Ethernet, and others. Network 230 may comprise one or more LANs that may also be wireless. Network 230 may further include remote direct memory access (RDMA) hardware and/or software, transmission control protocol/internet protocol (TCP/IP) hardware and/or software, router, repeaters, switches, grids, and/or others. Protocols such as Fibre Channel, Fibre Channel over Ethernet (FCoE), iSCSI, and so forth may be used in network 230. The network 230 may interface with a set of communications protocols used for the Internet such as the Transmission Control Protocol (TCP) and the Internet Protocol (IP), or TCP/IP.

In one embodiment, each host machine 210A-210B may be associated with one or more data storage devices 260A-260B. Examples of data storage devices include solid-state drives (SSDs), flash memory, magnetic or optical disks, tape drives, RAID arrays, EEPROM devices, storage area networks, network-attached storage, and/or any other devices capable of storing data.

Host machines 210A-210B may each include one or more processing devices 220A-220B, each comprising one or more processor cores. Each processor core includes circuitry for executing instructions according to a predefined general-purpose instruction set. The processor cores may access cache memory subsystems for data and computer program instructions. The cache subsystems may be coupled to a memory hierarchy comprising random access memory (RAM) 250A-250B and a storage device 260A-260B.

In one embodiment, network architecture 200 further includes management node 270. Management node 270 may be a standalone machine connected to host machines 210A-210B via network 230 or may be distributed across two or more physical machines, including host machines 210A-210B and/or other machines. In one embodiment, management node 270 includes an instance of storage scripting 110 and of solutions enabler 120. In another embodiment, storage scripting 110 and solutions enabler 120 may run on different nodes in the network architecture 200.

In one embodiment, storage scripting 110 issues one or more commands to solutions enabler 120, which in turn queries storage platform 130 for the information specified in the commands from storage scripting 110. The requested information may be stored in memory 250A-250B on one of host machines 210A-210B or on one of storage devices 260A-B. In one embodiment, solutions enabler 120 receives the requested information from storage platform 130 and provides a data array including the requested information to storage scripting 110. Depending on the embodiment, any of various types of information may be requested and obtained by storage scripting 110. In one example, storage scripting 110 may request a logical unit identifier (e.g., LUN ID) of storage provisioned in storage platform 130. In a situation where solutions enabler 120 and storage platform 130 do not permit a direct request for the logical unit identifier, however, storage scripting 110 may instead issue a series of commands to obtain the desired information. For example, storage scripting 110 may provide an indication of a masking view corresponding to the provisioned storage and receive a data array comprising an indication of a contents of the masking view. Storage scripting 110 may then identify a host machine (e.g., host machines 210A) from the contents of the masking view and send a command to identify one or more storage devices associated with that host machine. Solutions enabler 120 may provide an indication of those storage devices (e.g., storage device 260A). Storage scripting 110 may then send another command requesting the logical unit identifier associated with the storage device 260A and upon receiving the logical unit identifier may update the data array accordingly.

Upon retrieving the logical unit identifier for the provisioned storage, storage scripting may provide the logical unit identifier to server administration node 280. Server administration node 280 may be a separate node accessible by the server administration team. The server administration team may use the logical unit identifier to access the provisioned storage on storage platform, install an operating system or other computer application programs, and/or take other actions to generally make the provisioned storage usable by the enterprise.

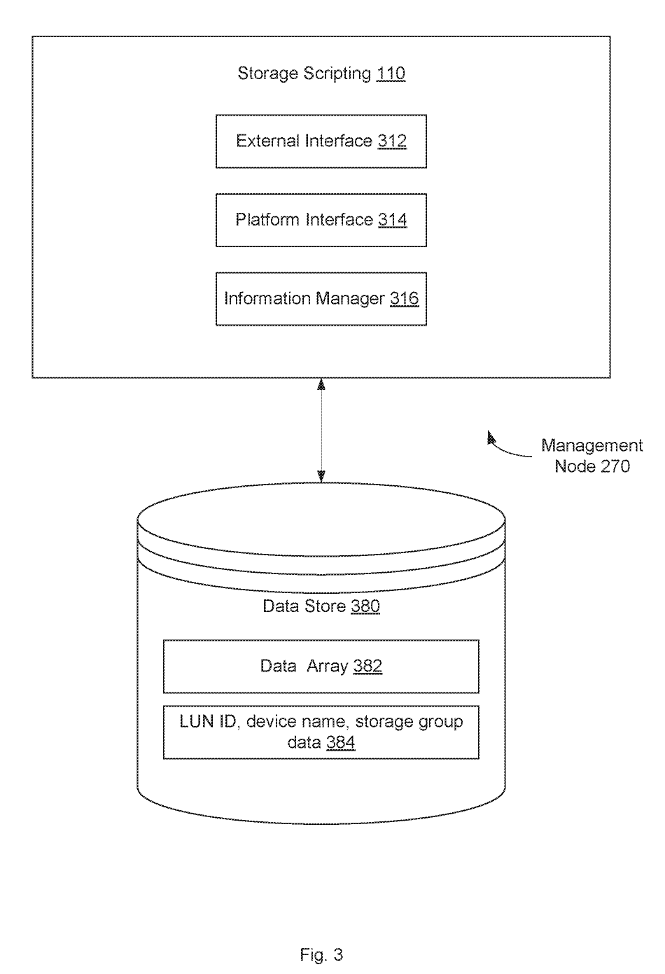

FIG. 3 is a block diagram illustrating storage scripting 110, according to an embodiment. In one embodiment, storage scripting 110 includes external interface 312, platform interface 314 and information manager 316. This arrangement of modules and components may be a logical separation, and in other embodiments, these modules or other components can be combined together or separated in further components, according to a particular implementation. The embodiment of storage scripting 110 illustrated in FIG. 3 may be representative of any instances of storage scripting 110, discussed above with respect to FIGS. 1 and 2. In one embodiment, data store 380 is connected to storage scripting 110 and includes data array 382 and LUN ID, device name, storage group data 384. In one implementation, a single physical machine (e.g., management node 270) may include both storage scripting 110 and data store 380. In another embodiment, data store 380 may be external to the physical machine, and may be connected over a network or other connection. In other implementations, storage scripting 110 may include different and/or additional components which are not shown to simplify the description. Data store 380 may be embodied on one or more mass storage devices which can include, for example, flash memory, magnetic or optical disks, or tape drives; read-only memory (ROM); random-access memory (RAM); erasable programmable memory (e.g., EPROM and EEPROM); flash memory; or any other type of storage medium.

In one embodiment, external interface 312 handles all interaction with components outside of solutions enabler 120 and storage platform 130. For example, external interface 312 may receive instructions or commands from a member of the storage team in the enterprise, or from another user, via client device 205A. In one embodiment, external interface 312 may receive an indication of a masking view from client device 205A. In one embodiment, the masking view defines which storage devices of the storage platform 130 are exposed to which hosts. For example, the masking view may include a storage group containing an indication one or more storage devices or device groups, a port group containing an indication of one or more front-end director ports, and an initiator group containing an indication one or more host initiator ports. In essence, the masking view includes access control permissions to define which hosts can access which LUNs using which ports. In addition, external interface 312 may handle interaction with server administration node 280. For example, after storage scripting 110 acquires the LUN ID from storage platform 130 and updates the data array accordingly, external interface 312 may provide the LUN ID to server administration node 280 to allow the server administration team access to the storage provisioned on storage platform 130.

In one embodiment, platform interface 314 handles all interaction with solutions enabler 120 and storage platform 130. For example, platform interface 314 may provide the indication of the masking view received by external interface 312 to solutions enabler 120 or directly to storage platform 130. In addition, platform interface 314 may send commands to solutions enabler 120 or storage platform 130, such as commands to identify storage devices associated with a particular host machine, and commands requesting a logical unit identifier associated with a particular storage device, a human readable device name of a particular storage device, or a storage group identifier associated with a particular storage device. Furthermore, platform interface 314 may receive data items or pieces of information from solutions enabler 120 or storage platform 130, such as a data array comprising an indication of a contents of the masking view. In one embodiment, platform interface 314 may store this information as data array 382 in data store 380. In addition, platform interface may receive an indication of storage devices associated with a particular host machine, or a logical unit identifier, human readable device name, or storage group identifier associated with a particular storage device and may store this information as LUN ID, device name, storage group data 384 in data store 380.

In one embodiment, information manager 316 analyzes and correlates the information received by platform interface 314. For example, when platform interface 314 receives the data array comprising an indication of the contents of the masking view, information manager 316 may examine the contents of the masking view and identify at least one host machine. In one embodiment, when platform interface 314 receives the logical unit identifier, human readable device name, or storage group identifier associated with a particular storage device, information manager 316 may update the data array 382 stored in data stored 380 to reflect this additional information.

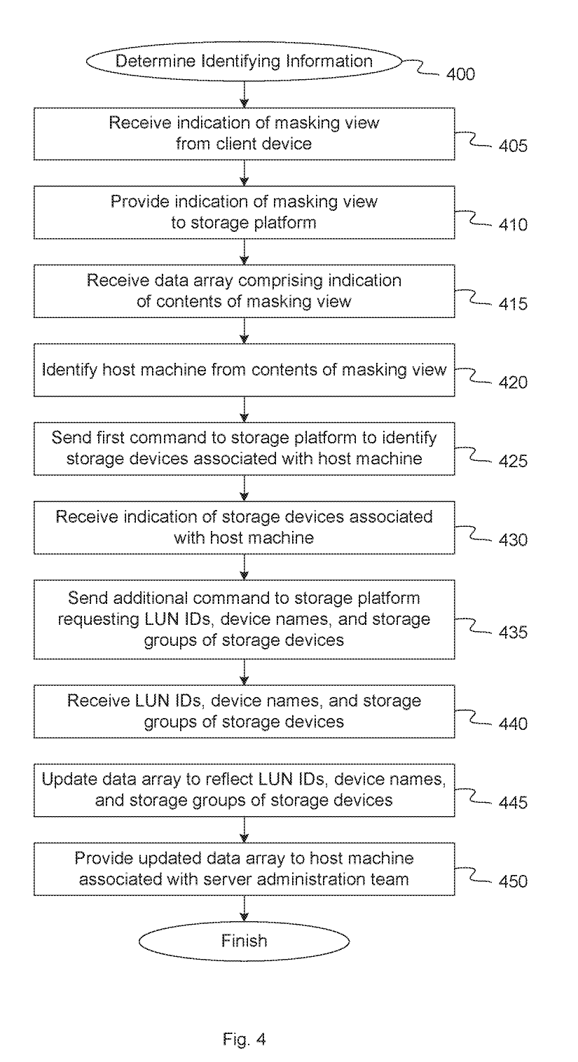

FIG. 4 is a flow diagram illustrating a method of determining identifying information from an enterprise storage platform, according to an embodiment. The method 400 may be performed by processing logic that comprises hardware (e.g., circuitry, dedicated logic, programmable logic, microcode, etc.), software, firmware, or a combination thereof. The processing logic is configured to obtain information about provisioned storage from the enterprise storage platform and automate the cross-referencing to obtain a logical unit identifier. In one embodiment, method 400 may be performed by storage scripting 110, as shown in FIGS. 1-3.

Referring to FIG. 4, at block 405, method 400 receives an indication of a masking view from a client device associated with a user. In one embodiment, external interface 312 may receive an indication of the masking view from client device 205A. The masking view may define which storage devices of the storage platform 130 are exposed to which hosts and may include a storage group containing an indication one or more storage devices or device groups, a port group containing an indication of one or more front-end director ports, and an initiator group containing an indication one or more host initiator ports.

At block 410, method 400 provides an indication of the masking view to the storage platform. In one embodiment, platform interface 314 provides the indication of the masking view received by external interface 312 at block 405 to solutions enabler 120 or directly to storage platform 130. In one embodiment, platform interface 314 provides an instruction and the indication of the masking view to solutions enabler 120, which in turn issues a command (e.g., a show masking view command) to storage platform 130.

At block 415, method 400 receives a data array comprising an indication of a contents of the masking view. In response to the show masking view command, platform interface 314 may receive the data array either from solutions enabler 120 or directly from storage platform 130. In one embodiment, the data array includes the contents of the storage group, the port group, and the initiator group, as discussed above. The data array, however, may be missing certain information such as a logical unit identifier, a human readable device name, and/or a storage group identifier associated storage devices in the masking view.

At block 420, method 400 identifies at least one host machine from the contents of the masking view. In one embodiment, information manager 316 may read data from the initiator group in data array 382 and select at least one host machine (e.g., host machine 210A). In a masking group, all host machines can generally see the same set of storage devices, so any host machine may be selected. In one embodiment, information manager 316 randomly selects one host machine from the initiator group. In another embodiment, information manager 316 selects the first host machine listed.

At block 425, method 400 sends a first command to the storage platform to identify storage devices associated with the at least one host machine. In one embodiment, platform interface 314 sends the first command (e.g., a list device info command) to solutions enabler 120 or directly to storage platform 130. The first command may request an indication of the storage devices attached to (i.e., masked to or visible to) the selected host machine 210A.

At block 430, method 400 receives an indication of one or more storage devices associated with the at least one host machine. In response to the list device info command, platform interface 314 may receive the list of storage devices from solutions enabler 120 or directly from storage platform 130. In one embodiment, platform interface 314 receives a list of hexadecimal identifiers of the storage devices (e.g., storage device 260A) attached to host machine 210A. In another embodiment, platform interface 314 receives the indication of the storage devices in some other format.

At block 435, method 400 sends additional commands (e.g., a second command, a third command, a fourth command) to the storage platform requesting a logical unit identifier, a human readable device name, and/or a storage group identifier associated with at least one of the one or more storage devices. In one embodiment, platform interface 314 may send the second, third, fourth commands, etc. to solutions enabler 120 or storage platform 130. In one embodiment, the logical unit identifier (e.g., LUN ID) is associated with a logical unit (e.g., a logical unit) formed across one or more of the storage devices in storage platform 130. The LUN ID may be used by the enterprise to identify and access the corresponding storage device 260A. In one embodiment, the human readable device name is an identifier written in ASCII text (e.g., “John's server”) associated with the storage device which was previously identified by a hexadecimal identifier received at block 430. In one embodiment, the storage group identifier indicates a storage group to which the corresponding storage device 260A belongs.

At block 440, method 400 receives the logical unit identifier, the human readable device name, and/or the storage group identifier. In response to the second, third, fourth command, etc., platform interface 314 may receive the requested information either from solutions enabler 120 or directly from storage platform 130.

At block 445, method 400 updates the data array to reflect the logical unit identifier, the human readable device name, and/or the storage group identifier. In one embodiment, the data array 382 received at block 415 contains an indication of the contents of the masking view. Information manager 316 can update the data array 382 with the LUN ID, device name, storage group data 384 received at block 440. In one embodiment, information manager 316 can correlate the received information with the data already present in data array 382. For example, information manager 316 can update an entry in data array 382 for a particular storage device 260A with the corresponding LUN ID, device name, storage group information.

At block 450, method 400 provides the updated data array to a host machine associated with a server administration team. In one embodiment, external interface 312 may provide the updated data array, including at least the LUN ID, to server administration node 280 to allow the server administration team access to the storage provisioned on storage platform 130. In another embodiment, external interface 312 may provide the updated data array to some other recipient or may store the updated data array in data store 380.

### II. Example System Overview

The following description is of one example of a system in which the features described above may be implemented. The components of the system described below are merely one example and should not be construed as limiting. The features described above with respect to FIGS. 1-4 may be implemented in any other type of computing environment, such as one with multiple servers, one with a single server, a multi-tenant server environment, a single-tenant server environment, or some combination of the above.

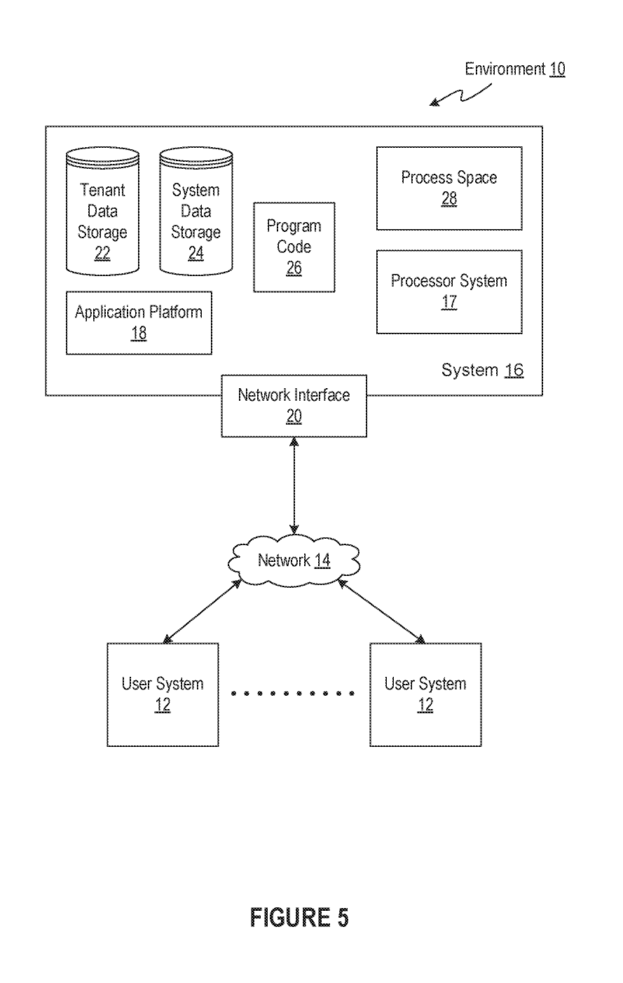

FIG. 5 shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

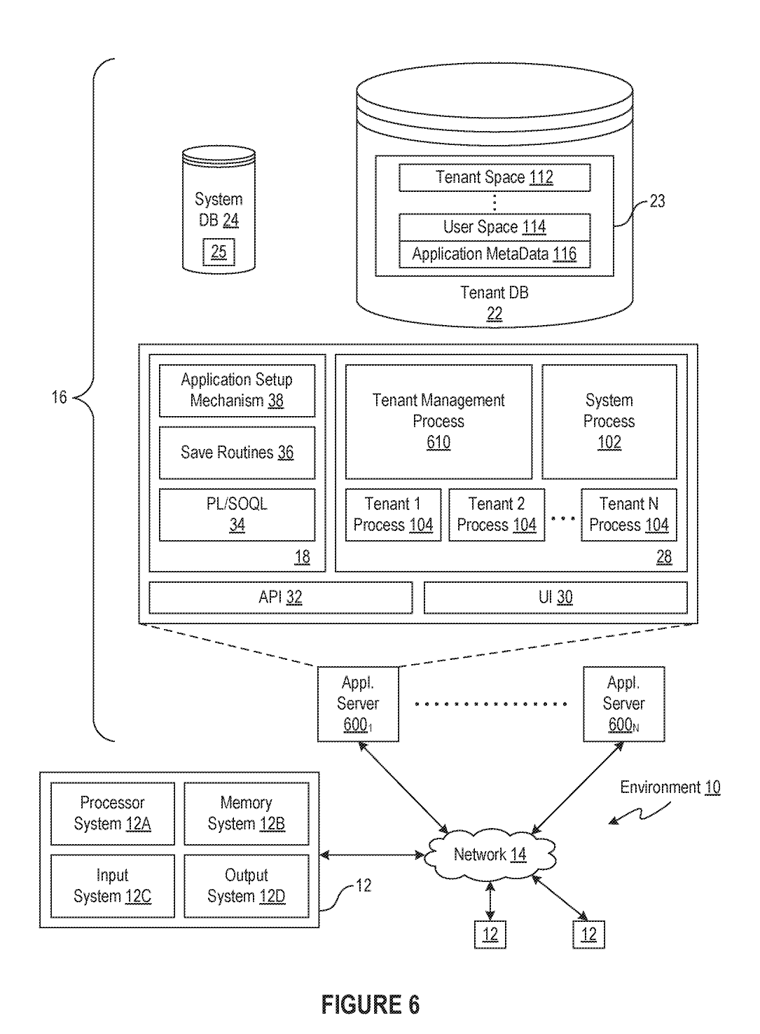

FIG. 6 shows a block diagram of example implementations of elements of FIG. 5 and example interconnections between these elements according to some implementations. That is, FIG. 6 also illustrates environment 10, but FIG. 6, various elements of the system 16 and various interconnections between such elements are shown with more specificity according to some more specific implementations. Additionally, in FIG. 6, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 6, the network interface 20 is implemented as a set of HTTP application servers 600₁-600_{N}. Each application server 600, also referred to herein as an “app server”, is configured to communicate with tenant database 22 and the tenant data 23 therein, as well as system database 24 and the system data 25 therein, to serve requests received from the user systems 12. The tenant data 23 can be divided into individual tenant storage spaces 112, which can be physically or logically arranged or divided. Within each tenant storage space 112, user storage 114 and application metadata 116 can similarly be allocated for each user. For example, a copy of a user's most recently used (MRU) items can be stored to user storage 114. Similarly, a copy of MRU items for an entire organization that is a tenant can be stored to tenant storage space 112.

The process space 28 includes system process space 102, individual tenant process spaces 104 and a tenant management process space 610. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process 610, for example. Invocations to such applications can be coded using PL/SOQL 34, which provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 816 for the subscriber making the invocation and executing the metadata as an application in a virtual machine.

The system 16 of FIG. 6 also includes a user interface (UI) 30 and an application programming interface (API) 32 to system 16 resident processes to users or developers at user systems 12. In some other implementations, the environment 10 may not have the same elements as those listed above or may have other elements instead of, or in addition to, those listed above.

Each application server 600 can be communicably coupled with tenant database 22 and system database 24, for example, having access to tenant data 23 and system data 25, respectively, via a different network connection. For example, one application server 600₁ can be coupled via the network 14 (for example, the Internet), another application server 600_{N-1} can be coupled via a direct network link, and another application server 600_{N} can be coupled by yet a different network connection. Transfer Control Protocol and Internet Protocol (TCP/IP) are examples of typical protocols that can be used for communicating between application servers 600 and the system 16. However, it will be apparent to one skilled in the art that other transport protocols can be used to optimize the system 16 depending on the network interconnections used.

In some implementations, each application server 600 is configured to handle requests for any user associated with any organization that is a tenant of the system 16. Because it can be desirable to be able to add and remove application servers 600 from the server pool at any time and for various reasons, in some implementations there is no server affinity for a user or organization to a specific application server 600. In some such implementations, an interface system implementing a load balancing function (for example, an F5 Big-IP load balancer) is communicably coupled between the application servers 600 and the user systems 12 to distribute requests to the application servers 600. In one implementation, the load balancer uses a least-connections algorithm to route user requests to the application servers 600. Other examples of load balancing algorithms, such as round robin and observed-response-time, also can be used. For example, in some instances, three consecutive requests from the same user could hit three different application servers 600, and three requests from different users could hit the same application server 600. In this manner, by way of example, system 16 can be a multi-tenant system in which system 16 handles storage of, and access to, different objects, data and applications across disparate users and organizations.

In one example storage use case, one tenant can be a company that employs a sales force where each salesperson uses system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 16 also can maintain system level data usable by multiple tenants or other data. Such system level data can include industry reports, news, postings, and the like that are sharable among tenants.

In some implementations, the user systems 12 (which also can be client systems) communicate with the application servers 600 to request and update system-level and tenant-level data from the system 16. Such requests and updates can involve sending one or more queries to tenant database 22 or system database 24. The system 16 (for example, an application server 600 in the system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

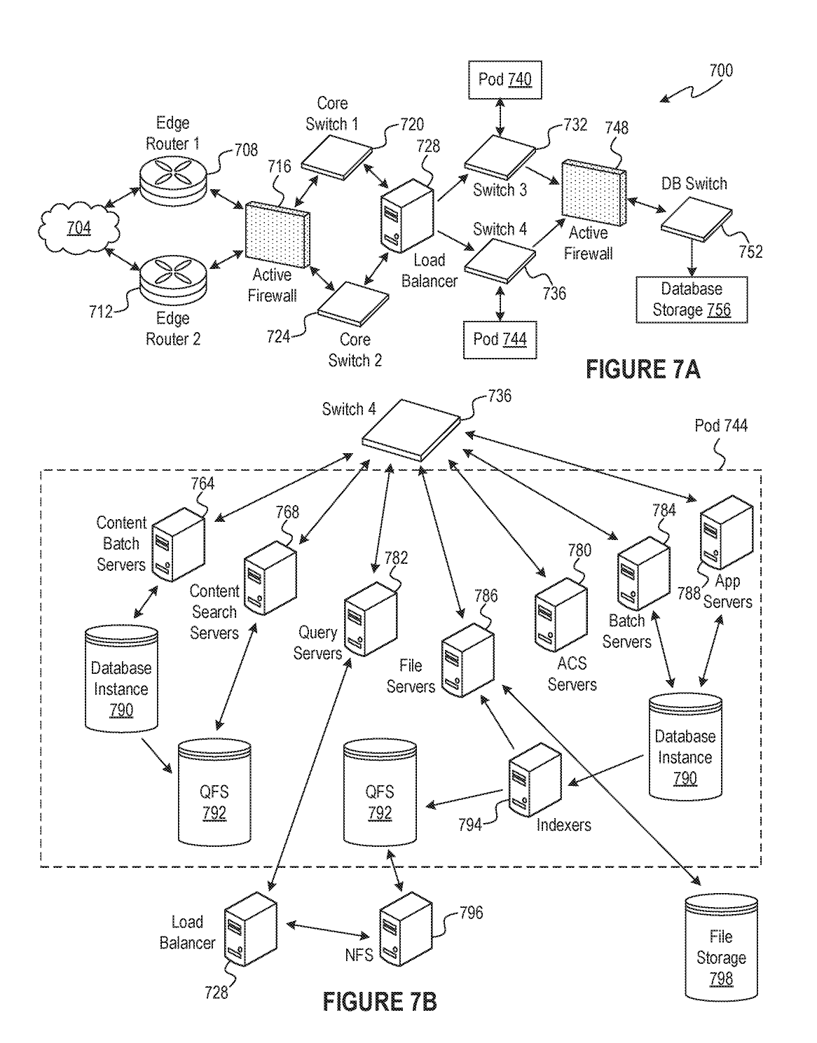

FIG. 7A shows a system diagram illustrating example architectural components of an on-demand database service environment 700 according to some implementations. A client machine communicably connected with the cloud 704, generally referring to one or more networks in combination, as described herein, can communicate with the on-demand database service environment 700 via one or more edge routers 708 and 712. A client machine can be any of the examples of user systems 12 described above. The edge routers can communicate with one or more core switches 720 and 724 through a firewall 716. The core switches can communicate with a load balancer 728, which can distribute server load over different pods, such as the pods 740 and 744. The pods 740 and 744, which can each include one or more servers or other computing resources, can perform data processing and other operations used to provide on-demand services. Communication with the pods can be conducted via pod switches 732 and 736. Components of the on-demand database service environment can communicate with database storage 756 through a database firewall 748 and a database switch 752.

As shown in FIGS. 7A and 7B, accessing an on-demand database service environment can involve communications transmitted among a variety of different hardware or software components. Further, the on-demand database service environment 700 is a simplified representation of an actual on-demand database service environment. For example, while only one or two devices of each type are shown in FIGS. 7A and 7B, some implementations of an on-demand database service environment can include anywhere from one to several devices of each type. Also, the on-demand database service environment need not include each device shown in FIGS. 7A and 7B, or can include additional devices not shown in FIGS. 7A and 7B.

Additionally, it should be appreciated that one or more of the devices in the on-demand database service environment 700 can be implemented on the same physical device or on different hardware. Some devices can be implemented using hardware or a combination of hardware and software. Thus, terms such as “data processing apparatus,” “machine,” “server” and “device” as used herein are not limited to a single hardware device, rather references to these terms can include any suitable combination of hardware and software configured to provide the described functionality.

The cloud 704 is intended to refer to a data network or multiple data networks, often including the Internet. Client machines communicably connected with the cloud 704 can communicate with other components of the on-demand database service environment 700 to access services provided by the on-demand database service environment. For example, client machines can access the on-demand database service environment to retrieve, store, edit, or process information. In some implementations, the edge routers 708 and 712 route packets between the cloud 704 and other components of the on-demand database service environment 700. For example, the edge routers 708 and 712 can employ the Border Gateway Protocol (BGP). The BGP is the core routing protocol of the Internet. The edge routers 708 and 712 can maintain a table of IP networks or ‘prefixes’, which designate network reachability among autonomous systems on the Internet.

In some implementations, the firewall 716 can protect the inner components of the on-demand database service environment 700 from Internet traffic. The firewall 716 can block, permit, or deny access to the inner components of the on-demand database service environment 700 based upon a set of rules and other criteria. The firewall 716 can act as one or more of a packet filter, an application gateway, a stateful filter, a proxy server, or any other type of firewall.

In some implementations, the core switches 720 and 724 are high-capacity switches that transfer packets within the on-demand database service environment 700. The core switches 720 and 724 can be configured as network bridges that quickly route data between different components within the on-demand database service environment. In some implementations, the use of two or more core switches 720 and 724 can provide redundancy or reduced latency.

In some implementations, the pods 740 and 744 perform the core data processing and service functions provided by the on-demand database service environment. Each pod can include various types of hardware or software computing resources. An example of the pod architecture is discussed in greater detail with reference to FIG. 7B. In some implementations, communication between the pods 740 and 744 is conducted via the pod switches 732 and 736. The pod switches 732 and 736 can facilitate communication between the pods 740 and 744 and client machines communicably connected with the cloud 704, for example via core switches 720 and 724. Also, the pod switches 732 and 736 may facilitate communication between the pods 740 and 744 and the database storage 756. In some implementations, the load balancer 728 can distribute workload between the pods 740 and 744. Balancing the on-demand service requests between the pods can assist in improving the use of resources, increasing throughput, reducing response times, or reducing overhead. The load balancer 728 may include multilayer switches to analyze and forward traffic.

In some implementations, access to the database storage 756 is guarded by a database firewall 748. The database firewall 748 can act as a computer application firewall operating at the database application layer of a protocol stack. The database firewall 748 can protect the database storage 756 from application attacks such as structure query language (SQL) injection, database rootkits, and unauthorized information disclosure. In some implementations, the database firewall 748 includes a host using one or more forms of reverse proxy services to proxy traffic before passing it to a gateway router. The database firewall 748 can inspect the contents of database traffic and block certain content or database requests. The database firewall 748 can work on the SQL application level atop the TCP/IP stack, managing applications' connection to the database or SQL management interfaces as well as intercepting and enforcing packets traveling to or from a database network or application interface.

In some implementations, communication with the database storage 756 is conducted via the database switch 752. The multi-tenant database storage 756 can include more than one hardware or software components for handling database queries. Accordingly, the database switch 752 can direct database queries transmitted by other components of the on-demand database service environment (for example, the pods 740 and 744) to the correct components within the database storage 756. In some implementations, the database storage 756 is an on-demand database system shared by many different organizations as described above with reference to FIG. 5 and FIG. 6.

FIG. 7B shows a system diagram further illustrating example architectural components of an on-demand database service environment according to some implementations. The pod 744 can be used to render services to a user of the on-demand database service environment 700. In some implementations, each pod includes a variety of servers or other systems. The pod 744 includes one or more content batch servers 764, content search servers 768, query servers 782, file force servers 786, access control system (ACS) servers 780, batch servers 784, and app servers 788. The pod 744 also can include database instances 790, quick file systems (QFS) 792, and indexers 794. In some implementations, some or all communication between the servers in the pod 744 can be transmitted via the switch 736.

In some implementations, the app servers 788 include a hardware or software framework dedicated to the execution of procedures (for example, programs, routines, scripts) for supporting the construction of applications provided by the on-demand database service environment 700 via the pod 744. In some implementations, the hardware or software framework of an app server 788 is configured to execute operations of the services described herein, including performance of the blocks of various methods or processes described herein. In some alternative implementations, two or more app servers 288 can be included and cooperate to perform such methods, or one or more other servers described herein can be configured to perform the disclosed methods.

The content batch servers 764 can handle requests internal to the pod. Some such requests can be long-running or not tied to a particular customer. For example, the content batch servers 764 can handle requests related to log mining, cleanup work, and maintenance tasks. The content search servers 768 can provide query and indexer functions. For example, the functions provided by the content search servers 768 can allow users to search through content stored in the on-demand database service environment. The file force servers 786 can manage requests for information stored in the File force storage 798. The File force storage 798 can store information such as documents, images, and basic large objects (BLOBs). By managing requests for information using the file force servers 786, the image footprint on the database can be reduced. The query servers 782 can be used to retrieve information from one or more file systems. For example, the query system 782 can receive requests for information from the app servers 788 and transmit information queries to the NFS 796 located outside the pod.

The pod 744 can share a database instance 790 configured as a multi-tenant environment in which different organizations share access to the same database. Additionally, services rendered by the pod 744 may call upon various hardware or software resources. In some implementations, the ACS servers 780 control access to data, hardware resources, or software resources. In some implementations, the batch servers 784 process batch jobs, which are used to run tasks at specified times. For example, the batch servers 784 can transmit instructions to other servers, such as the app servers 788, to trigger the batch jobs.

In some implementations, the QFS 792 is an open source file system available from Sun Microsystems® of Santa Clara, Calif. The QFS can serve as a rapid-access file system for storing and accessing information available within the pod 744. The QFS 792 can support some volume management capabilities, allowing many disks to be grouped together into a file system. File system metadata can be kept on a separate set of disks, which can be useful for streaming applications where long disk seeks cannot be tolerated. Thus, the QFS system can communicate with one or more content search servers 768 or indexers 794 to identify, retrieve, move, or update data stored in the network file systems 796 or other storage systems.

In some implementations, one or more query servers 782 communicate with the NFS 796 to retrieve or update information stored outside of the pod 744. The NFS 796 can allow servers located in the pod 744 to access information to access files over a network in a manner similar to how local storage is accessed. In some implementations, queries from the query servers 782 are transmitted to the NFS 796 via the load balancer 728, which can distribute resource requests over various resources available in the on-demand database service environment. The NFS 796 also can communicate with the QFS 792 to update the information stored on the NFS 796 or to provide information to the QFS 792 for use by servers located within the pod 744.

In some implementations, the pod includes one or more database instances 790. The database instance 790 can transmit information to the QFS 792. When information is transmitted to the QFS, it can be available for use by servers within the pod 744 without using an additional database call. In some implementations, database information is transmitted to the indexer 794. Indexer 794 can provide an index of information available in the database 790 or QFS 792. The index information can be provided to file force servers 786 or the QFS 792.

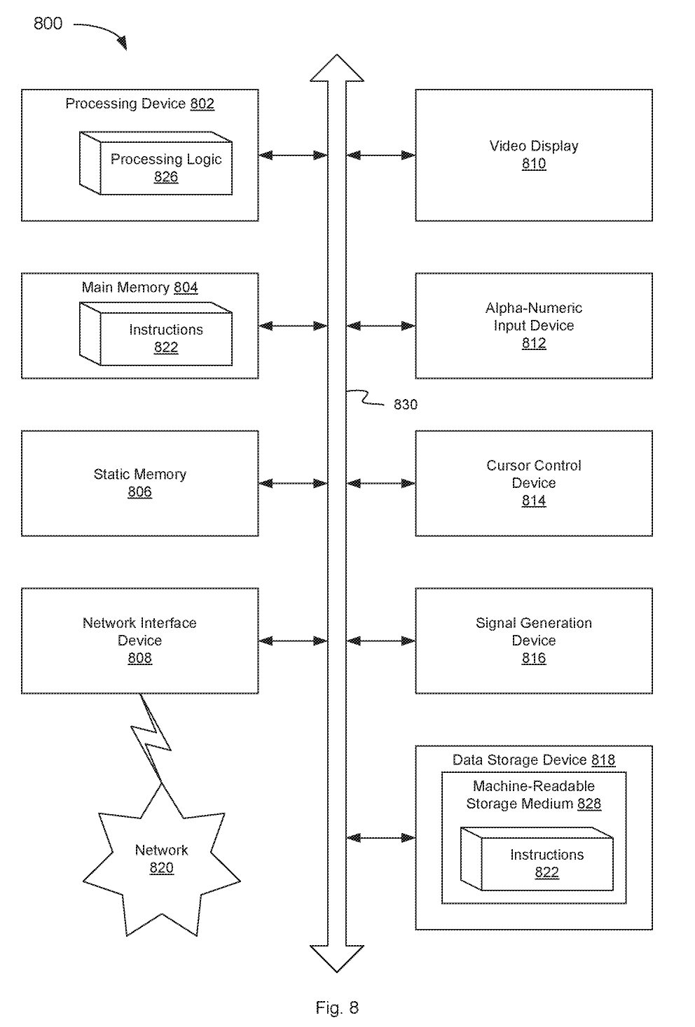

FIG. 8 illustrates a diagrammatic representation of a machine in the exemplary form of a computer system 800 within which a set of instructions, for causing the machine to perform any one or more of the methodologies discussed herein, may be executed. The system 800 may be in the form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 800 may represent any of host machines 210A-210B, client devices 205A-N, management node 270 or server administration node 280, as described above.

The exemplary computer system 800 includes a processing device (processor) 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)), and a data storage device 818, which communicate with each other via a bus 830.

Processing device 802 represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also be one or more special-purpose processing devices such as an application specific integrated circuit (ASIC), a field programmable gate array (FPGA), a digital signal processor (DSP), network processor, or the like. The processing device 802 is configured to execute the notification manager 210 for performing the operations and steps discussed herein.

The computer system 800 may further include a network interface device 808. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 816 (e.g., a speaker).

The data storage device 818 may include a computer-readable medium 828 on which is stored one or more sets of instructions 822 (e.g., instructions of infrastructure monitor 170) embodying any one or more of the methodologies or functions described herein. The instructions 822 may also reside, completely or at least partially, within the main memory 804 and/or within processing logic 826 of the processing device 802 during execution thereof by the computer system 800, the main memory 804 and the processing device 802 also constituting computer-readable media. The instructions may further be transmitted or received over a network 820 via the network interface device 808.

While the computer-readable storage medium 828 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining”, “identifying”, “adding”, “selecting” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
providing an indication of a masking view to a storage platform;
receiving a data array comprising an indication of a contents of the masking view;
identifying, by a processing device, at least one host machine from the contents of the masking view;
sending a first command to the storage platform to identify storage devices associated with the at least one host machine;
receiving an indication of one or more storage devices associated with the at least one host machine;
sending a second command to the storage platform requesting a logical unit identifier associated with at least one of the one or more storage devices;
receiving the logical unit identifier; and
updating the data array to reflect the logical unit identifier.

2. The method of claim 1, further comprising:
receiving the indication of the masking view from a client device associated with a user, the masking view to define which storage devices of the storage platform are exposed to which hosts.

3. The method of claim 1, further comprising:
sending the first and second commands to a software component associated with the storage platform, the software component running on a host machine and configured to translate the first and second commands to a format compatible with the storage platform.

4. The method of claim 1, wherein receiving the indication of the one or more storage devices associated with the at least one host comprises receiving a list of hexadecimal identifiers of the one or more storage devices.

5. The method of claim 1, further comprising:
sending a third command to the storage platform requesting a human readable device name of the at least one of the one or more storage devices;
receiving the human readable device name; and
updating the data array to reflect the human readable device name.

6. The method of claim 1, further comprising:
sending a fourth command to the storage platform requesting a storage group identifier associated with the at least one of the one or more storage devices;
receiving the storage group identifier; and
updating the data array to reflect the storage group identifier.

7. The method of claim 1, further comprising:
providing the updated data array to a host machine associated with a server administration team.

8. A server comprising:
a memory; and
a processing device operatively coupled to the memory, the processing device to:
provide an indication of a masking view to a storage platform;
receive a data array comprising an indication of a contents of the masking view;
identify at least one host machine from the contents of the masking view;
send a first command to the storage platform to identify storage devices associated with the at least one host machine;
receive an indication of one or more storage devices associated with the at least one host machine;
send a second command to the storage platform requesting a logical unit identifier associated with at least one of the one or more storage devices;
receive the logical unit identifier; and
update the data array to reflect the logical unit identifier.

9. The server of claim 8, wherein the processing device further to:
receive the indication of the masking view from a client device associated with a user, the masking view to define which storage devices of the storage platform are exposed to which hosts.

10. The server of claim 8, wherein the processing device further to:
send the first and second commands to a software component associated with the storage platform, the software component running on a host machine and configured to translate the first and second commands to a format compatible with the storage platform.

11. The server of claim 8, wherein the indication of the one or more storage devices associated with the at least one host comprises a list of hexadecimal identifiers of the one or more storage devices.

12. The server of claim 8, wherein the processing device further to:
send a third command to the storage platform requesting a human readable device name of the at least one of the one or more storage devices;
receive the human readable device name; and
update the data array to reflect the human readable device name.

13. The server of claim 8, wherein the processing device further to:
send a fourth command to the storage platform requesting a storage group identifier associated with the at least one of the one or more storage devices;
receive the storage group identifier; and
update the data array to reflect the storage group identifier.

14. The server of claim 8, wherein the processing device further to:
provide the updated data array to a host machine associated with a server administration team.

15. A non-transitory computer-readable storage medium storing instructions which, when executed by a processing device, are capable of causing the processing device to:
provide an indication of a masking view to a storage platform;
receive a data array comprising an indication of a contents of the masking view;
identify at least one host machine from the contents of the masking view;
send a first command to the storage platform to identify storage devices associated with the at least one host machine;
receive an indication of one or more storage devices associated with the at least one host machine;
send a second command to the storage platform requesting a logical unit identifier associated with at least one of the one or more storage devices;
receive the logical unit identifier; and
update the data array to reflect the logical unit identifier.

16. The non-transitory computer-readable storage medium of claim 15, wherein the instructions are further capable of causing the processing device to:
receive the indication of the masking view from a client device associated with a user, the masking view to define which storage devices of the storage platform are exposed to which hosts.

17. The non-transitory computer-readable storage medium of claim 15, wherein the instructions are further capable of causing the processing device to:
send the first and second commands to a software component associated with the storage platform, the software component running on a host machine and configured to translate the first and second commands to a format compatible with the storage platform.

18. The non-transitory computer-readable storage medium of claim 15, wherein the indication of the one or more storage devices associated with the at least one host comprises a list of hexadecimal identifiers of the one or more storage devices.

19. The non-transitory computer-readable storage medium of claim 15, wherein the instructions are further capable of causing the processing device to:
send a third command to the storage platform requesting a human readable device name of the at least one of the one or more storage devices;
receive the human readable device name; and
update the data array to reflect the human readable device name.

20. The non-transitory computer-readable storage medium of claim 15, wherein the instructions are further capable of causing the processing device to:
send a fourth command to the storage platform requesting a storage group identifier associated with the at least one of the one or more storage devices;
receive the storage group identifier; and
update the data array to reflect the storage group identifier.
